(19) United States
(12) Patent Application Publication
(10) Pub. No.: US 2026/0366437 A1
(43) Pub. Date: Nov. 19, 2026

(54) Low Pressure Shaft Configurations for Improved Maintainability

(71) Applicant: Pratt & Whitney Canada Corp., Longueuil, Québec (CA)

(72) Inventors: Eduardo HAWIE, Woodbridge, Ontario (CA); Jerzy MAKUSZEWSKI, Mississauga, Ontario (CA)

(21) Appl. No.: 19/208,993

(22) Filed: May 15, 2025

(51) Int. Cl. F01D 25/24

(52) U.S. Cl. CPC F01D 25/24; F05D 2220/36; F05D 2260/31

(57) ABSTRACT

A gas turbine engine includes a shaft rotatable about an engine central longitudinal axis, a turbine configured to drive rotation of the shaft about the engine central longitudinal axis, and a fan operably connected to the shaft and configured to rotate therewith. The fan includes a fan hub and a plurality of fan blades extending radially outwardly from the fan hub. A compressor rotor is connected to the fan and is configured to rotate therewith. The compressor rotor includes a compressor rotor arm extending toward the fan hub. A plurality of compressor arm bolts extends through the fan compressor arm to secure the fan to the compressor rotor. The plurality of compressor arm bolts are configured and positioned for removal from an axially upstream side of the compressor rotor arm.

### FIELD

Exemplary embodiments of the present disclosure pertain to the art of gas turbine engines.

### BACKGROUND

Gas turbine engines typically include numerous rotating components arranged along one or more shafts. The shafts and rotating components are supported by bearings, such as roller bearings, journal bearings or the like, that are lubricated by a flow of, for example, oil. One or more seals are located at or near the bearing arrangements to prevent the leakage of lubricant into unintended portions of the gas turbine engine.

These bearings and seals are periodically subjected to maintenance operations such as inspection, repair or replacement. Such periodic maintenance operations serve to ensure the gas turbine engine meets its intended service life. In many gas turbine engines, to access the bearing and seal arrangement at an axially forward end of a low pressure shaft of the gas turbine engine, significant disassembly of the engine is often required. This access is more limited in engine configurations where the fan rotor is an integrally bladed rotor. The art would readily appreciate improvement of access to components at or near the bearing.

### SUMMARY

In one embodiment, a gas turbine engine includes a shaft rotatable about an engine central longitudinal axis, a turbine configured to drive rotation of the shaft about the engine central longitudinal axis, and a fan operably connected to the shaft and configured to rotate therewith. The fan includes a fan hub and a plurality of fan blades extending radially outwardly from the fan hub. A compressor rotor is connected to the fan and is configured to rotate therewith. The compressor rotor includes a compressor rotor arm extending toward the fan hub. A plurality of compressor arm bolts extends through the fan compressor arm to secure the fan to the compressor rotor. The plurality of compressor arm bolts are configured and positioned for removal from an axially upstream side of the compressor rotor arm.

Additionally or alternatively, in this or other embodiments the fan hub is a unitary single piece structure extending to the shaft and connected directly to the shaft.

Additionally or alternatively, in this or other embodiments the plurality of compressor arm bolts extends through the fan hub to secure the compressor arm to the fan hub.

Additionally or alternatively, in this or other embodiments an intermediate shaft extends from the fan hub to the shaft. The intermediate shaft is connected to the shaft, and the plurality of compressor arm bolts extends through the intermediate shaft.

Additionally or alternatively, in this or other embodiments the plurality of compressor arm bolts extends through all of the fan hub, the intermediate shaft and the compressor arm.

Additionally or alternatively, in this or other embodiments the intermediate shaft is positioned axially between the fan hub and the compressor arm at the plurality of compressor arm bolts.

Additionally or alternatively, in this or other embodiments the compressor arm is positioned axially between the fan hub and the intermediate shaft at the plurality of compressor arm bolts.

Additionally or alternatively, in this or other embodiments the intermediate shaft includes a first intermediate arm. A plurality of fan hub bolts extends through the first intermediate arm and the fan hub. The intermediate shaft further includes a second intermediate arm. The plurality of compressor arm belts extends through the second intermediate arm and the compressor arm.

Additionally or alternatively, in this or other embodiments the plurality of fan hub bolts are configured and positioned for removal from an axially upstream side of the fan hub.

Additionally or alternatively, in this or other embodiments the fan hub is secured to the shaft via a spline connection.

In another embodiment, a fan and compressor assembly of a gas turbine engine includes a shaft rotatable about an engine central longitudinal axis, and a fan operably connected to the shaft and configured to rotate therewith. The fan includes a fan hub and a plurality of fan blades extending radially outwardly from the fan hub. A compressor rotor is connected to the fan and is configured to rotate therewith. The compressor rotor includes a compressor rotor arm extending toward the fan hub. A plurality of compressor arm bolts extends through the fan compressor arm to secure the fan to the compressor rotor. The plurality of compressor arm bolts are configured and positioned for removal from an axially upstream side of the compressor rotor arm.

Additionally or alternatively, in this or other embodiments the fan hub is a unitary single piece structure extending to the shaft and connected directly to the shaft.

Additionally or alternatively, in this or other embodiments the plurality of compressor arm bolts extend through the fan hub to secure the compressor arm to the fan hub.

Additionally or alternatively, in this or other embodiments an intermediate shaft extends from the fan hub to the shaft. The intermediate shaft is connected to the shaft. The plurality of compressor arm bolts extends through the intermediate shaft.

Additionally or alternatively, in this or other embodiments the plurality of compressor arm bolts extend through all of the fan hub, the intermediate shaft and the compressor arm.

Additionally or alternatively, in this or other embodiments the intermediate shaft is positioned axially between the fan hub and the compressor arm at the plurality of compressor arm bolts.

Additionally or alternatively, in this or other embodiments the compressor arm is positioned axially between the fan hub and the intermediate shaft at the plurality of compressor arm bolts.

Additionally or alternatively, in this or other embodiments the intermediate shaft includes a first intermediate arm, with a plurality of fan hub bolts extending through the first intermediate arm and the fan hub. The intermediate shaft further includes a second intermediate arm with the plurality of compressor arm belts extending through the second intermediate arm and the compressor arm.

Additionally or alternatively, in this or other embodiments the plurality of fan hub bolts are configured and positioned for removal from an axially upstream side of the fan hub.

Additionally or alternatively, in this or other embodiments the fan hub is secured to the shaft via a spline connection.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a partial cross-sectional view of a fan and low pressure compressor portion of a gas turbine engine;

FIG. 3 is a cross-sectional view of an embodiment of a fan and low pressure compressor attachment to a shaft;

FIG. 4 is a cross-sectional view of another embodiment of a fan and low pressure compressor attachment to a shaft;

FIG. 5 is a cross-sectional view of yet another embodiment of a fan and low pressure compressor attachment to a shaft; and

FIG. 6 is a cross-sectional view of still another embodiment of a fan and low pressure compressor attachment to a shaft.

### DETAILED DESCRIPTION

A detailed description of one or more embodiments of the disclosed apparatus and method are presented herein by way of exemplification and not limitation with reference to the Figures.

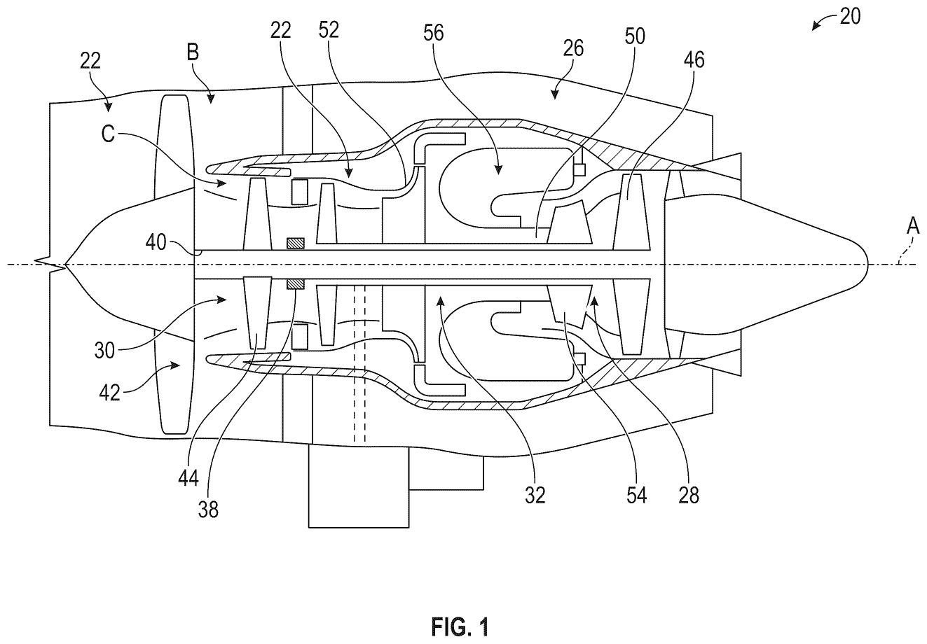

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, and the turbine section 28, may be varied.

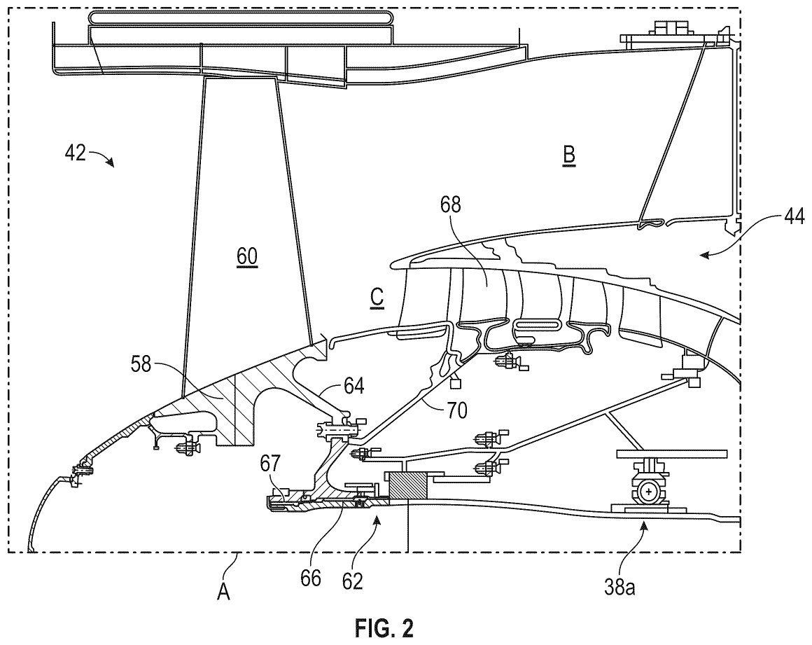

Referring now to FIG. 2, in some embodiments the fan 42 includes a fan hub 58 located at the engine central longitudinal axis A and a plurality of fan blades 60 extending radially outwardly from the fan hub 58. The fan 42 is an integrally bladed rotor configuration, in which the fan blades 60 and the fan hub 58 are formed as a single unitary component. A first bearing 38a, and a first bearing seal 62 are located axially downstream of the fan hub 58.

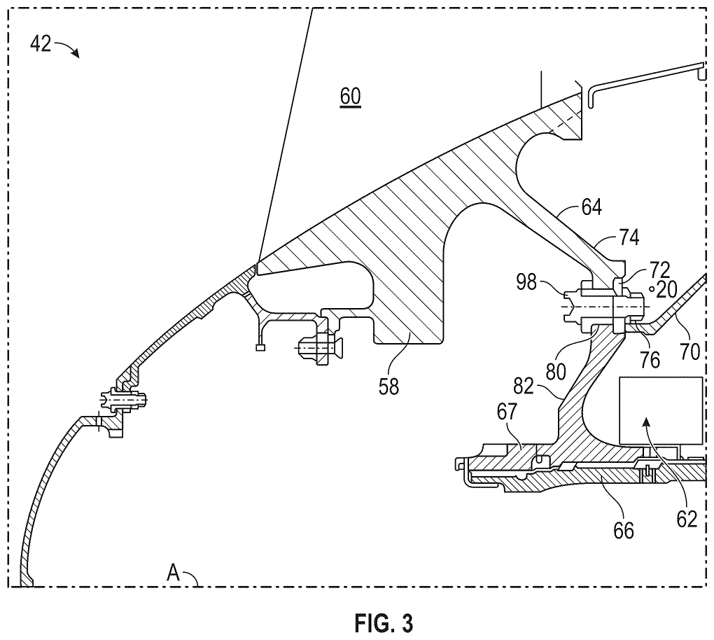

Referring now to FIG. 3, the fan hub 58 extends to the inner shaft 40 and is connected directly to the inner shaft 40. More particularly, the fan hub 58 includes a connection flange 64 that extends axially along the inner shaft 40. The connection flange 64 is connected to the inner shaft 40 via a spline interface 66 therebetween. The connection flange 64 is axially retained to the inner shaft 40 by a retention nut 67 installed onto the inner shaft 40. As shown in FIG. 2, the low pressure compressor 44 includes a low pressure compressor (LPC) rotor 68 that is connected to and rotates with the fan 42. Referring again to FIG. 3, the LPC rotor 68 includes an LPC arm 70 that extends toward the fan hub 58 and is secured to the fan hub 58. In one embodiment, the LPC arm 70 includes an LPC arm flange 72, which in some embodiments is located at a distal end of the LPC arm 70. The LPC arm flange 72 axially abuts the fan hub 58 at an axially downstream side 74 of the fan hub 58 and includes a plurality of LPC arm flange openings 76 formed therein. A plurality of LPC arm bolts 98 are installed through the fan hub 58 at a plurality of fan hub openings 80, and through the plurality of LPC arm flange openings 76. When torqued, the LPC arm bolts 98 secure the fan 42 to the LPC rotor 68. The LPC arm bolts 98 are accessible from an axially upstream side 82 of the fan hub 58 for easy installation and removal of the LPC arm bolts 98. Once the LPC arm bolts 98 are removed, the fan 42 may be removed, thus providing access to the first bearing 38a, and a first bearing seal 62, located radially inboard of the LPC arm flange 72.

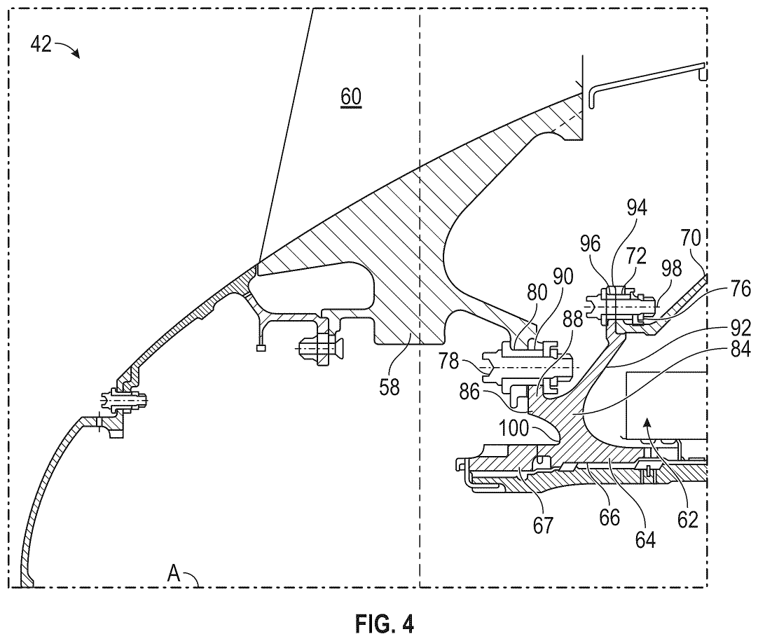

Referring now to FIG. 4, in some embodiments the fan hub 58 is not secured directly to the inner shaft 40, but via an intermediate shaft 84 secured to the fan hub 58. The intermediate shaft 84 includes the connection flange 64, which is connected to the inner shaft 40 via the spline interface 66. The intermediate shaft 84 is axially retained to the inner shaft 40 via the retention nut 67 installed onto the inner shaft 40. The intermediate shaft 84 includes a first intermediate arm 86 extending toward the fan hub 58 and having a first arm flange 88 including a plurality of first bolt openings 90. A plurality of fan hub bolts 78 are installed through the plurality of fan hub openings 80 and through the first bolt openings 90. When torqued, the plurality of fan hub bolts 78 secure the fan 42 to the intermediate shaft 84.

The intermediate shaft 84 further includes a second intermediate arm 92 extending toward the LPC arm 70. The LPC arm flange 72 abuts a second arm flange 94 of the second intermediate arm 92. The second arm flange 94 includes a plurality of second bolt openings 96. A plurality of LPC arm bolts 98 are installed through the second bolt openings 96 and through the LPC arm flange openings 76. When the LPC arm bolts 98 are torqued, the LPC rotor 68 is secured to the second intermediate arm 92. Both the fan hub bolts 78 and the LPC arm bolts 98 are accessible from an axially upstream side 100 of the intermediate shaft 84, for ease of installation and removal thereof. Once the fan 42 and the intermediate shaft 84 are removed, the first bearing 38a and the first bearing seal 62, located radially inboard of the LPC arm flange 72, may be accessed for maintenance.

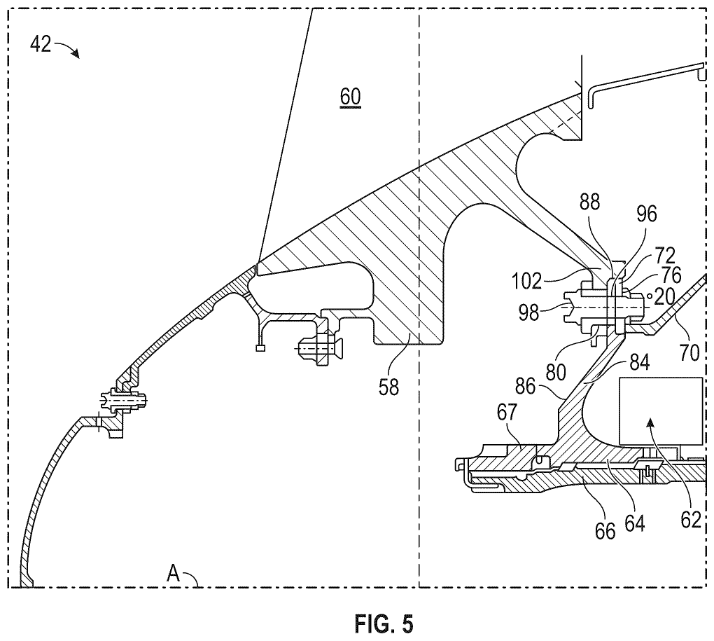

Another embodiment is illustrated in FIG. 5. In this embodiment, the second intermediate arm is omitted, and the first intermediate arm 86 is connected to both the fan hub 58 and the LPC arm 70. The fan hub 58 includes a fan hub flange 102, which is axially stacked together with the first arm flange 88 and the LPC arm flange 72. The plurality of fan hub openings 80 are located in the fan hub flange 102, and the plurality of LPC arm bolts 98 are installed through all three of the fan hub openings 80, the second bolt openings 96 and the LPC arm flange openings 76, thus securing the fan 42, the intermediate shaft 84 and the LPC rotor 68 together. In the embodiment of FIG. 5, the first arm flange 88 is axially positioned between the fan hub flange 102 and the LPC arm flange 72.

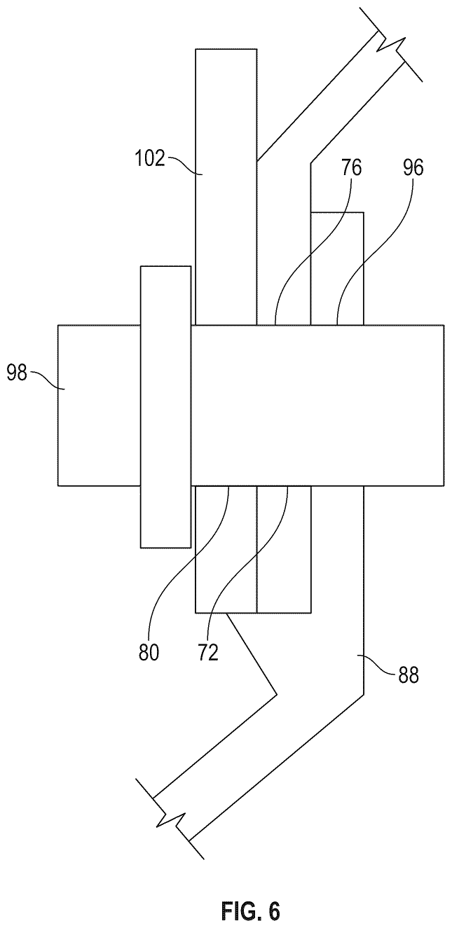

In alternative embodiments, such as illustrated in FIG. 6, the axial stack arrangement may differ. For example, the LPC arm flange 72 may be positioned axially between the first arm flange 88 and the fan hub flange 102. In the embodiments of FIGS. 5 and 6, the LPC arm bolts 98 are accessible from the axially upstream side 82 of the fan hub 58 for easy installation and removal of the LPC arm bolts 98. Once the LPC arm bolts 98 are removed, the fan 42 and the intermediate shaft 84 may be removed, thus providing access to the first bearing 38a, and the first bearing seal 62, located radially inboard of the LPC arm flange 72.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A gas turbine engine, comprising:
a shaft rotatable about an engine central longitudinal axis;
a turbine configured to drive rotation of the shaft about the engine central longitudinal axis;
a fan operably connected to the shaft and configured to rotate therewith, the fan including:
a fan hub; and
a plurality of fan blades extending radially outwardly from the fan hub;
a compressor rotor connected to the fan and configured to rotate therewith, the compressor rotor including a compressor rotor arm extending toward the fan hub;
a plurality of compressor arm bolts extending through the fan compressor arm to secure the fan to the compressor rotor, the plurality of compressor arm bolts configured and positioned for removal from an axially upstream side of the compressor rotor arm; and
an intermediate shaft extending from the fan hub to the shaft, the intermediate shaft connected to the shaft, the plurality of compressor arm bolts extending through the intermediate shaft;
wherein the plurality of compressor arm bolts extend through all of the fan hub, the intermediate shaft and the compressor arm.

2. The gas turbine engine of claim 1, wherein the fan hub is a unitary single piece structure extending to the shaft and connected directly to the shaft.

3. The gas turbine engine of claim 2, wherein the plurality of compressor arm bolts extend through the fan hub to secure the compressor arm to the fan hub.

4. (canceled)

5. (canceled)

6. The gas turbine engine of claim 1, wherein the intermediate shaft is disposed axially between the fan hub and the compressor arm at the plurality of compressor arm bolts.

7. The gas turbine engine of claim 1, wherein the compressor arm is disposed axially between the fan hub and the intermediate shaft at the plurality of compressor arm bolts.

8. The gas turbine engine of claim 1, wherein the intermediate shaft includes:
a first intermediate arm, a plurality of fan hub bolts extending through the first intermediate arm and the fan hub; and
a second intermediate arm, the plurality of compressor arm belts bolts extending through the second intermediate arm and the compressor arm.

9. The gas turbine engine of claim 8, the plurality of fan hub bolts configured and positioned for removal from an axially upstream side of the fan hub.

10. The gas turbine engine of claim 1, wherein the fan hub is secured to the shaft via a spline connection.

11. A fan and compressor assembly of a gas turbine engine, comprising:
a shaft rotatable about an engine central longitudinal axis;
a fan operably connected to the shaft and configured to rotate therewith, the fan including:
a fan hub; and
a plurality of fan blades extending radially outwardly from the fan hub;
a compressor rotor connected to the fan and configured to rotate therewith, the compressor rotor including a compressor rotor arm extending toward the fan hub;
a plurality of compressor arm bolts extending through the fan compressor arm to secure the fan to the compressor rotor, the plurality of compressor arm bolts configured and positioned for removal from an axially upstream side of the compressor rotor arm; and
an intermediate shaft extending from the fan hub to the shaft, the intermediate shaft connected to the shaft, the plurality of compressor arm bolts extending through the intermediate shaft;
wherein the plurality of compressor arm bolts extend through all of the fan hub, the intermediate shaft and the compressor arm.

12. The fan and compressor assembly of claim 11, wherein the fan hub is a unitary single piece structure extending to the shaft and connected directly to the shaft.

13. The fan and compressor assembly of claim 12, wherein the plurality of compressor arm bolts extend through the fan hub to secure the compressor arm to the fan hub.

14. (canceled)

15. (canceled)

16. The fan and compressor assembly of claim 11, wherein the intermediate shaft is disposed axially between the fan hub and the compressor arm at the plurality of compressor arm bolts.

17. The fan and compressor assembly of claim 11, wherein the compressor arm is disposed axially between the fan hub and the intermediate shaft at the plurality of compressor arm bolts.

18. The fan and compressor assembly of claim 11, wherein the intermediate shaft includes:
a first intermediate arm, a plurality of fan hub bolts extending through the first intermediate arm and the fan hub; and
a second intermediate arm, the plurality of compressor arm bolts extending through the second intermediate arm and the compressor arm.

19. The fan and compressor assembly of claim 18, wherein the plurality of fan hub bolts are configured and positioned for removal from an axially upstream side of the fan hub.

20. The fan and compressor assembly of claim 11, wherein the fan hub is secured to the shaft via a spline connection.
